(19) United States
(12) Patent Application Publication
(10) Pub. No.: US 2019/0211933 A1
(43) Pub. Date: Jul. 11, 2019

(54) A BUTTERFLY VALVE DISC ARRANGEMENT

(71) Applicant: FlowMECS AB, Torslanda (SE)

(72) Inventor: Per WIGREN, Torslanda (SE)

(73) Assignee: FlowMECS AB, Torslanda (SE)

(21) Appl. No.: 16/099,326

(22) PCT Filed: May 15, 2017
(86) PCT No.: PCT/SE2017/050499

§ 371 Date: Nov. 6, 2018

(30) Foreign Application Priority Data
May 16, 2016 (SE) 1650654-5

(51) Int. Cl. F16K 1/226

(52) U.S. Cl. CPC F16K 1/2261

(57) ABSTRACT

A butterfly valve disc arrangement comprising a valve disc arranged to be rotatably movable between an open position and a closed position of a valve body, said valve disc comprising a circumferentially arranged recess disposed about a periphery of the valve disc; a sealing ring arranged in said circumferentially arranged recess of said valve disc and configured to provide a radial seal against an inner surface of said valve body when said valve disc is arranged in the closed position; and a resilient member arranged between a first surface of the circumferentially arranged recess and a first surface of the sealing ring for providing a seal between a second surface of the sealing ring and a second surface of the circumferentially arranged recess.

### TECHNICAL FIELD

The present invention relates to a butterfly valve disc arrangement and in particular to a butterfly valve disc arrangement comprising a resilient member arranged between a valve disc and a sealing ring. The invention also relates to a butterfly valve comprising such a butterfly valve disc arrangement.

### BACKGROUND

Butterfly valves are used in a wide variety of applications, such as for example, large cargo ships, pharmaceutical industry, chemical industry, and food industry, etc. The purposes of the butterfly valves are to controllably prevent media or flow to pass through the valve within its specific process. The specific type of media or flow depends of course on the application of use but can e.g. be liquids or gases of varying kind.

The butterfly valve generally comprises a circularly shaped valve disc which is connected to a valve body by means of a shaft. The shaft and the valve disc are hence connected to each other and installed in the valve body. By rotating the shaft, the valve disc can be positioned in an open state to allow liquid or gases to pass through the butterfly valve, and in a closed state to prevent liquid or gases to pass through the butterfly valve. In order to further prevent liquid or gases to pass through the butterfly valve when the valve disc is positioned in its closed state, a circumferentially arranged sealing ring is often positioned around the periphery of the valve disc. Hereby, a radial seal is provided between the valve disc and the valve body.

An example of a butterfly valve is given in EP 2 515 014. The butterfly valve in EP 2 515 014 comprises a disc member with an opening for receiving a shaft and a seal ring. The butterfly valve further comprises a retainer connecting the seal ring to the disc member by means of bolts and nuts at a lower portion of the disc member.

Although the butterfly valve in EP 2 515 014 may provide an improved fixation of the seal to the valve disc in relation to its own prior art, there is still room for further improvements in terms of, for example, improved sealing as well as to reduce the number of components used.

### SUMMARY

It is an object of the present invention to provide a butterfly valve arrangement which at least partially overcomes the deficiencies of the prior art. This is achieved by a butterfly valve disc arrangement according to claim 1.

According to a first aspect of the present invention, there is provided a butterfly valve disc arrangement comprising a valve disc arranged to be rotatably movable between an open position and a closed position of a valve body, the valve disc comprising a circumferentially arranged recess disposed about a periphery of the valve disc; a sealing ring arranged in the circumferentially arranged recess of the valve disc and configured to provide a radial seal against an inner surface of the valve body when the valve disc is arranged in the closed position; and a resilient member arranged between a first surface of the circumferentially arranged recess and a first surface of the sealing ring for providing a seal between a second surface of the sealing ring and a second surface of the circumferentially arranged recess. The sealing ring further comprises an axially extending protruding portion at a radially lower portion of the sealing ring, the protruding portion extending from the first surface in a direction away from the first surface of the sealing ring, wherein an upper surface of the axially extending protruding portion of the sealing ring is arranged at a non-zero distance from a radially lower portion of the resilient member when the valve disc is arranged in the closed position.

The resilient member should in the following and throughout the description be interpreted as a member adapted to provide a pressure on the first surface of the sealing ring. The resilient member may have springing characteristics for being pressed between the first surface of the circumferentially arranged recess and the first surface of the sealing ring. Thus, the first surface of the sealing ring, or at least portions of the first surface of the sealing ring, is exposed to a continuous pressure from the resilient member.

Furthermore, the circumferentially arranged recess should be understood as a recess extending radially from an outer radial position and in a direction towards a center portion thereof and arranged around the circumferential direction of the valve disc.

An advantage of the present invention is that a continuous axial seal is provided between the sealing ring and the valve disc. In particular, a continuous axial seal is provided between a surface of the valve disc and the sealing ring. Hence, the sealing ring of the present invention provides for a radial seal against an inner surface of the valve body when the valve disc is arranged in its closed position as well as an axial seal against a surface of the circumferentially arranged recess.

The axial seal is beneficial as it will further improve the sealing properties for the valve disc arrangement when the valve disc is arranged in its closed position. This is accomplished since dust particles or the like is prevented from slipping into the sealing area between the second surface of the sealing ring and the second surface of the circumferentially arranged recess, at any given position of the butterfly valve disc arrangement, i.e. the opened position, the closed position, or any position there between. By preventing dust particles or the like from being directed between the second surface of the sealing ring and the second surface of the circumferentially arranged recess will also increase the operational life time of both the sealing ring as well as the valve disc. The sealing ring is a movable part which radially slides against at least the second surface of the circumferentially arranged recess. Thus, if dust particles or the like becomes present at this sliding surface, the surface structure of the respective parts will be worn down and eventually needed to be replaced. This is prevented by means of the resilient member which provides a continuous seal between the second surface of the sealing ring and the second surface of the circumferentially arranged recess. Hence, dust particles or the like are prevented from being provided to this part of the butterfly valve disc arrangement also when the valve disc is arranged in its open position.

Furthermore, using the described resilient member is beneficial for low pressure applications, such as e.g. flue gas applications. In these applications, the friction force between the radially outer surface of the sealing ring and the interior surface of the valve body which arises during opening and/or closing of the butterfly valve disc arrangement is relatively high in comparison to the axial compression force exerted on the sealing ring by these fluids/gases. Thus, the resilient member compensates for the low pressure of the fluids/gases to provide for a sufficient axial force on the sealing ring.

A further advantage is that an axial seal is provided throughout the entire circumferential direction of the sealing ring. The valve disc is opened and closed by rotation of a shaft connected to the valve disc. Therefore, when closing the valve disc, the friction forces acting between the radial surface of the sealing ring and the interior surface of the valve body will have a component force in opposite directions on each side of the shaft. Hence, on one side of the shaft, the friction force between the valve body and the sealing ring will force the sealing ring towards the second surface of the circumferentially arranged recess of the valve disc, while on the other side of the shaft, the friction force between the valve body and the sealing ring will force the sealing ring away from the second surface of the circumferentially arranged recess of the valve disc. The resilient member thus advantageously pushes the sealing ring against the second surface of the circumferentially arranged recess which provides for a sufficient axial seal. Without the resilient member the sealing ring would hence be forced away from the second surface. As an example, the axial compression force exerted on the sealing ring should preferably exceed the friction force between the radially outer surface of the sealing ring and the interior surface of the valve body which arises during opening and/or closing of the butterfly valve disc arrangement.

As a still further advantage in view of the prior art, the valve disc arrangement described above comprises a less number of components in order to function properly, thus providing an economically advantageous product. Also, the structure of the butterfly valve disc arrangement reduces the risk of loosen components since the butterfly valve disc arrangement needs to be removed from the valve body before the resilient member and the sealing ring can be removed from the butterfly valve disc arrangement. Moreover, the resilient member will provide the sealing ring in an axially pretension manner and the sealing ring will provide a radial pretension against the valve body. Hereby, improved vibration characteristics of the sealing surfaces are provided.

Furthermore, the resilient member also has the functionality of a retainer for the sealing ring. In detail, when the valve disc is opened, i.e. directed from its closed position towards its open position, the sealing ring will expand in the radial direction. After sufficient expansion, the upper surface of the axially extending protruding portion of the sealing ring will abut, i.e. contact, the radially lower portion of the resilient member. Hence, the radially lower portion of the resilient member controls the amount of expansion of the sealing ring. Furthermore, the non-zero distance between the upper surface of the axially extending protruding portion and the radially lower portion of the resilient member enables for sufficient expansion of the sealing ring when the valve disc is arranged in the closed position. Hereby, a sufficient radial compression force can be provided between the sealing ring and the valve body. Hence, the axially extending protruding portion extends in a direction of the surface normal of the first surface of the sealing ring. In other words, the axially extending protruding portion extends in a direction towards the flow direction when the valve disc is arranged in the closed position.

According to an example embodiment, the resilient member may be an axial spring.

An axial spring should be understood to mean a spring which provides a compression in the axial direction of the butterfly valve disc arrangement. An axial spring may be chosen to provide a sufficient compression force against the first surface of the sealing ring, which compression force should exceed the friction force arising between the radially upper surface of the sealing ring and the interior surface of the valve body when the valve disc is being opened or closed.

According to an example embodiment, the resilient member may be a continuous axial spring extending around the circumferential direction of the recess. Hereby, a continuous compression force is provided onto the first surface of the sealing ring around the circumferential direction thereof, which thus provides sufficient axial seal around the entire second surface.

According to an example embodiment, the first and second surfaces of the sealing ring may be axially opposed surfaces arranged on each side of the sealing ring.

The wording “axial opposed surfaces” should not be construed as limited to two surfaces being perpendicular to each other. On the contrary, the first and second surfaces may be arranged slightly inclined relative to each other. The wording “axially opposed surfaces” thus rather defines that the surfaces are arranged on different sides of the sealing ring as seen in the axial direction thereof.

According to an example embodiment, the sealing ring may be a piston ring comprising a circumferentially extending protrusion at a first end portion of the piston ring and a groove portion at a second end portion of the piston ring, the circumferentially extending protrusion being arranged in the groove portion. Hereby, a gas tight piston ring is provided.

A gas tight piston ring is a sealing ring which prevents gas, or any other flowing media, from being transferred through the sealing ring joint, in the axial as well as the radial direction thereof. An advantage of the gas tight piston ring is that the dimensions thereof, i.e. the circumferentially extending protrusion and the groove portion, approximately eliminates the circumferential, radial and axial gap between end portions of the sealing ring, at which gap gases otherwise can be transferred through the sealing ring when the valve disc is arranged in its closed position.

The usage of a piston ring, and especially a gas tight piston ring as sealing element, allows for large temperature transients of the valve disc arrangement. The piston ring is flexible and able to adopt in shape in order to maintain an efficient seal without the risk of being stuck in the disc or valve body. As the piston ring is made gas tight, it can be designed to withstand large temperature increases without having an increased leakage zone in the joint. The solution using a piston ring as a sealing element is thus less sensitive to temperature transients compared to a precision ground conical metal seat, which is used in many types of high performance valves. Further the high performance valve is very sensitive to dust and particles being trapped between the disc and seat. Once a particle is trapped and dented to the disc or seat, the valve will start leaking. The axial pressure between the disc and seat is in general very high to achieve tightness for a high performance valve. Using a gas tight piston ring on the other hand, the pressure levels on the sealing surfaces can be kept low or moderate during operation.

Other alternative gas tight piston rings are of course conceivable as well, such as e.g. duplex rings, i.e. a combination of more than one piston ring without gas tight joints. Hereby, a plurality of piston rings are arranged radially and/or axially relative to each other, with the respective end portions arranged on different circumferential positions relative to each other.

According to an example embodiment, the circumferentially arranged recess may comprise a protruding portion extending in a direction towards the sealing ring. Hereby, the protruding portion of the recess may act as a support for the sealing ring such that the sealing ring is prevented from tilting in the recess. In particular, the protruding portion of the sealing ring in conjunction with the protruding portion of the circumferentially arranged recess may provide a beneficial support for preventing the sealing ring from tilting. Accordingly, the sealing ring can be provided in a stable vertical position. The protruding portion of the recess should be understood as a protrusion of the valve disc into the recess.

According to a second aspect there is provided a butterfly valve comprising a valve body and a butterfly valve disc arrangement, wherein the butterfly valve disc arrangement comprises a valve disc rotatably movable between an open position and a closed position of the valve body, the valve disc comprising a circumferentially arranged recess disposed about a periphery of the valve disc; a sealing ring arranged in the circumferentially arranged recess of the valve disc and configured to provide a radial seal against an inner surface of the valve body when the valve disc is arranged in the closed position; and a resilient member arranged between a first surface of the circumferentially arranged recess and a first surface of the sealing ring for providing a seal between a second surface of the sealing ring and a second surface of the circumferentially arranged recess.

Effects and features of the second aspect are largely analogous to those described above in relation to the first aspect of the present invention.

Further features of, and advantages with, the present invention will become apparent when studying the appended claims and the following description. The skilled person realize that different features of the present invention may be combined to create embodiments other than those described in the following, without departing from the scope of the present invention.

### BRIEF DESCRIPTION OF THE DRAWINGS

The above, as well as additional objects, features and advantages of the present invention, will be better understood through the following illustrative and non-limiting detailed description of exemplary embodiments of the present invention, wherein:

FIG. 1 is a perspective view illustrating a butterfly valve according to an example embodiment of the present invention;

FIG. 2 is an exploded perspective view of the butterfly valve in FIGS. 1; and

FIG. 3 is a radial cross-section of the valve disc arrangement in its closed position according to an example embodiment of the present invention.

### DETAILED DESCRIPTION

The present invention will now be described more fully hereinafter with reference to the accompanying drawings, in which exemplary embodiments of the invention are shown. The invention may, however, be embodied in many different forms and should not be construed as limited to the embodiments set forth herein; rather, these embodiments are provided for thoroughness and completeness. Like reference character refer to like elements throughout the description.

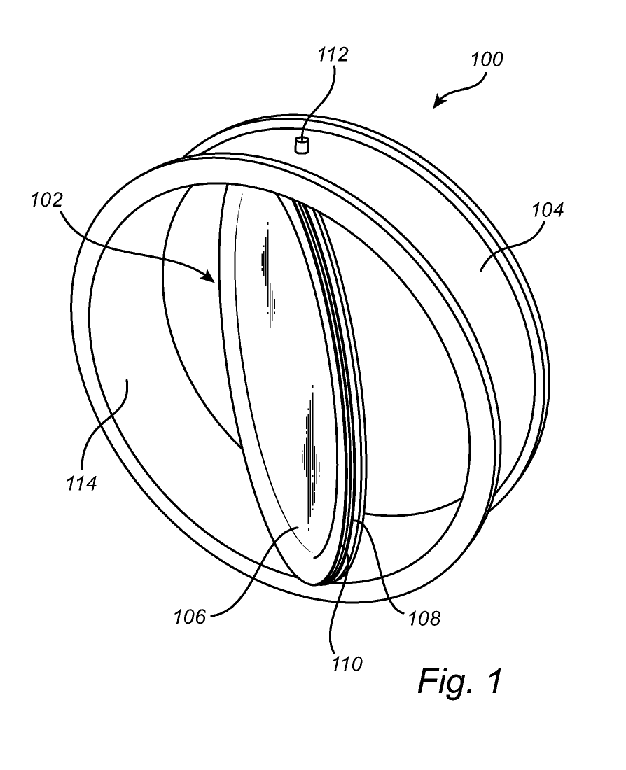

With particular reference to FIG. 1 there is provided a butterfly valve 100 according to an example embodiment. The butterfly valve 100 comprises a butterfly valve disc arrangement 102 and a valve body 104. The butterfly valve disc arrangement 102, which will be described further below, comprises a valve disc 106, a sealing ring 108 and a resilient member 110. Furthermore, the butterfly valve 100 also comprises a shaft 112 which is connected to the valve disc 106 and to a suitable opening/closing arrangement (not shown). Hence, the valve disc 106 is opened/closed relative to the valve body 104 by means of rotating the shaft 112.

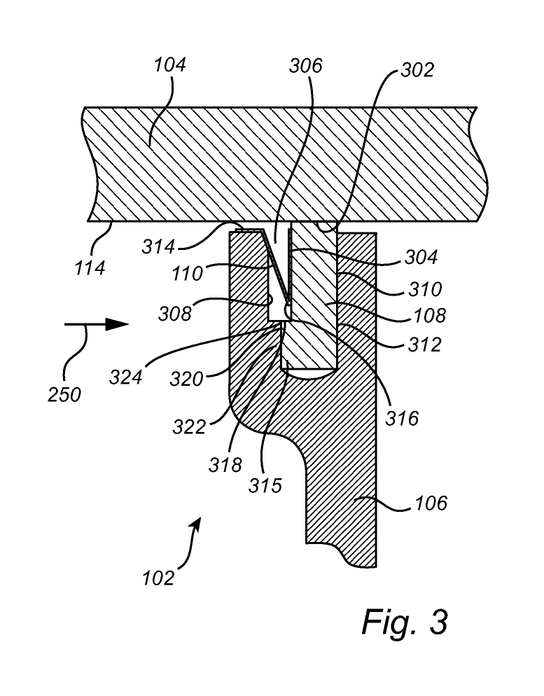

Moreover, the butterfly valve disc arrangement 102 is thus arranged to be movable in the valve body 104 between an open position where liquid and gases are allowed to pass through the butterfly valve 100, and a closed position where the liquid and gases are prevented from passing through the butterfly valve 100. In the latter position, the sealing ring 108 provides a radial seal against an inner surface 114 of the valve body 104. Furthermore, the resilient member 110 provides an axial seal for the sealing ring, which will be described in further detail below in relation to the description of FIG. 3.

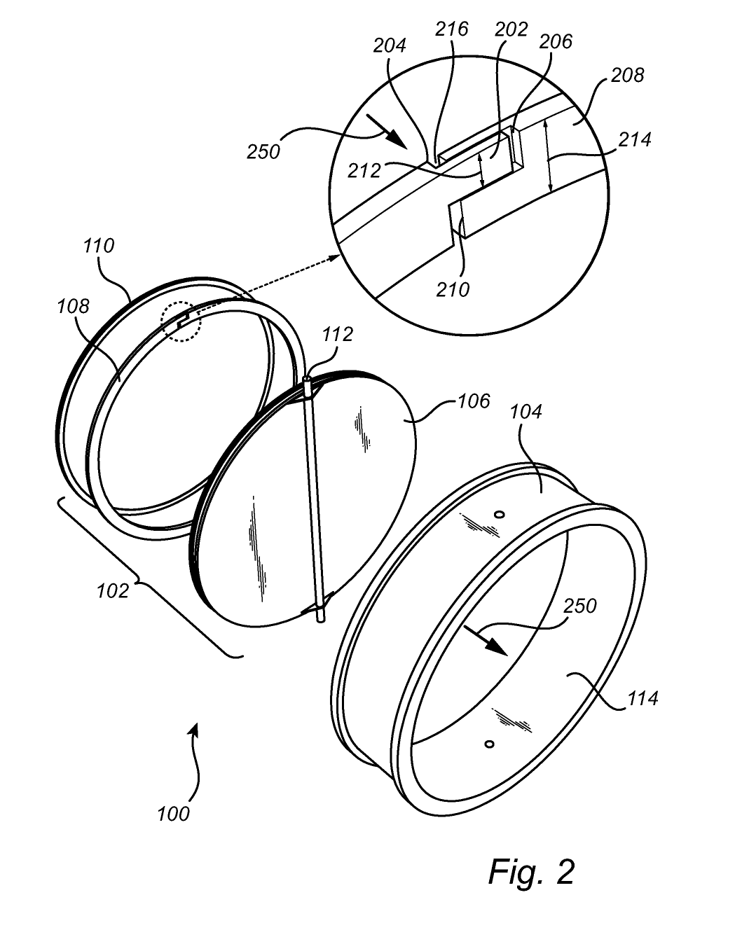

Turning to FIG. 2, which is an exploded perspective view of the valve disc 100 in FIG. 1 and its associated components. FIG. 2 thus especially illustrates the butterfly valve disc arrangement 102 and the valve body 104 in further detail. As described above, the butterfly valve disc arrangement 102 comprises the valve disc 106, the sealing ring 108 and the resilient member 110.

With particular reference to the detailed portion of the sealing ring 108 illustrated in FIG. 2, the sealing ring 108 is according to this example embodiment arranged as a gas tight piston ring 208. The gas tight piston ring 208 comprises a circumferentially extending protrusion 202 at a first end portion 204 of the piston ring 208. The circumferentially extending protrusion 202 is arranged in a groove portion 206, which groove portion 206 is arranged at a second end portion 210 of the piston ring 208. The cross-section of the second end portion 210, as seen in the circumferential direction, is formed in an L-shaped form having an upper and a lower portion as seen in the radial direction thereof. The lower portion of the L-shaped cross-section has a thickness in the axial direction of the piston ring which is greater than a thickness in the axial direction of the upper portion of the L-shaped cross-section. Thus, the groove portion 206 extends in the circumferential direction from the second end portion 210, in a direction away from the surface normal of the second end portion 210. Moreover, the circumferentially extending protrusion 202 comprises a radial height 212 which is smaller than the total radial height 214 of the piston ring 208. The groove portion 206 is thus naturally of dimensions to house the circumferentially extending protrusion 202. By means of the circumferentially extending protrusion 202 and the groove portion 206, gas flow (both fluids as well as gases) are prevented from flowing through the piston ring in both the axial direction as well as the radial direction thereof. By means of the above geometry properties of the sealing ring 108, both axial and radial flow is prevented from passing through the overlapping joint. The flow direction of the butterfly valve disc arrangement 102 is illustrated in FIG. 2 by the arrow numbered 250. Thus, the above described sealing ring is gas tight in the flow direction 250. The sealing ring is also gas tight in the opposite flow direction until the media induced axial force acting on the sealing ring is greater than the force induced by the resilient member, i.e. when the second surface 312 of the sealing ring 108 looses contact with the second surface 310 of the recess (See FIG. 3).

Other alternatives of a gas tight piston ring 208 are of course conceivable. For example, a plurality of piston rings may be arranged side by side in the radial and/or axial direction. In this arrangement, the distance 216 between the first 204 and second 210 end portions are positioned at different circumferential positions for each of the plurality of piston rings. Hereby, a gas tight piston ring assembly is arranged which prevents a radial and axial flow through the plurality of piston rings. An advantage is that this gas tight piston ring assembly is gas tight in both the flow direction 250 as well as in opposite direction to the depicted flow direction 250, irrespective of flow media pressure level.

It should thus be understood that when the butterfly valve disc arrangement 102 is arranged in its open position, the sealing ring 108, i.e. the piston ring 208, is radially expanded such that the distance 216 between the first 204 and second 210 end portions are increased. When the butterfly valve disc arrangement 102 is arranged in its closed position the inner surface 114 of the valve body 104, which inner surface 114 has a smaller circumference in comparison to the outer circumference of the sealing ring 108 when the butterfly valve disc arrangement 102 is arranged in its open position, will press against the sealing ring 108 for reducing the distance 216 between the first 204 and second 210 end portions.

Turning now to FIG. 3 which is a cross-section of the butterfly valve disc arrangement 102 in its closed position. In particular, FIG. 3 illustrates portions of the valve disc 106, the sealing ring 108, the resilient member 110 and the valve body 104. As said before, the butterfly valve disc arrangement 102 is arranged in its closed position in the valve body 104. Hereby, a radially outer surface 302 of the sealing ring 108 is arranged with a radial pressure against the inner surface 114 of the valve body 104, thus providing a seal there between.

The valve disc 106 comprises a circumferentially arranged recess 306 which is disposed about a periphery of the valve disc 106. The circumferentially arranged recess 306 of the valve disc 106 is arranged to at least partly house the resilient member 110 and the sealing ring 108. Hereby, the resilient member 110 and the sealing ring 108 are positioned axially between a first 308 and a second 310 surface of the circumferentially arranged recess 306. The first 308 and second 310 surfaces are arranged as opposed surfaces to each other and can, according to an example, be substantially parallel to each other.

Furthermore, the resilient member 110, which in the following is also referred to as an axial spring, is arranged to provide an axial compression force against a first surface 304 of the sealing ring 108. The first surface 304 of the sealing ring 108 is preferably having an extension in the radial and circumferential direction of the sealing ring. Hereby, the resilient member 110 is thus arranged with a compression force between the first surface 308 of the circumferentially arranged recess 306 and the first surface 304 of the sealing ring 108. The compression force of the resilient member should preferably, in order to maintain the sealing ring in position, exceed the friction force arising between the inner surface 114 of the valve body 104 and the radially outer surface 302 of the sealing ring 108 when the butterfly valve disc arrangement 102 is being opened and/or closed. This compression force of the resilient member 110 will provide for a compression force between a second surface 312 of the sealing ring 108 and the second surface of the second surface 310 of the circumferentially arranged recess 306. Hence, a seal between the second surface 312 of the sealing ring 108 and the second surface 310 of the circumferentially arranged recess 306 is provided. This is beneficial since particles are prevented from gaining access to this area, which particles could damage the second surface 310 of the circumferentially arranged recess 306 as well as the second surface 312 of the sealing ring 108. The second surface 312 of the sealing ring 108 and the second surface 310 of the circumferentially arranged recess 306 are thus arranged in contact with each other, which contact is a slidable contact surface which means that a radial movement of the sealing ring 108 relative to the valve disc 106 is allowed when the butterfly valve disc arrangement 102 is opened and/or closed.

Furthermore, the resilient member 110 also comprises an upper portion 314 arranged in contact with a portion of the periphery of the valve disc 106. In detail, the upper portion 314 of the resilient member 110 is arranged to provide a radially downward compression force against the portion of the periphery of the valve disc 106. This is accomplished by arranging the upper portion 314 of the resilient member 110 with a pretension. The radial compression force provides an improved sealing between the resilient member 110 and the portion of the periphery of the valve disc 106. Also, the resilient member 110 comprises a radially lower portion 316 which will be described further below.

As can be seen in FIG. 3, the sealing ring 108 comprises an axially extending protruding portion 315 at a radially lower portion thereof. The axially extending protruding portion 315 extends from the first surface 304 in a direction away from the first surface 304 of the sealing ring 108 and comprises an upper, substantially horizontal surface 318 and a substantially vertical end surface 320. The axially extending protruding portion 315 extends from the first surface 304 in the direction of the surface normal of the first surface 304. Hence, in a direction towards the above described flow direction 250 when the valve disc is closed. The upper surface 318 is preferably arranged at a non-zero distance from the radially lower portion 316 of the resilient member 110. Hereby, the resilient member 110 can act as a stop for the radial expansion of the sealing ring 108 when the butterfly valve disc arrangement 102 is opened. Furthermore, the vertical distance between the upper surface 318 of the protruding portion 315 and the radially lower portion 316 of the resilient member 110 may also be smaller than the vertical distance of a vertical end surface 324 of the protruding portion 315. The axially extending protrusion is thus arranged radially below the resilient member 110.

Furthermore, the circumferentially arranged recess 306 comprises a protruding portion 322 extending in a direction away from the first surface 308 of the circumferentially arranged recess 306 and in a direction towards the sealing ring 108. The end surface 324 of the protruding portion 322 is arranged in contact with the substantially vertical end surface 320 of the axially extending protruding portion 315 of the sealing ring 108. This contact is also a slidable contact surface which means that a radial movement of the sealing ring 108 relative to the valve disc 106 is allowed when the butterfly valve disc arrangement is opened and/or closed. Furthermore, the two slidable contact surfaces arranged on opposite axial sides of the sealing ring 108 are beneficial as they improve the stability of the sealing ring 108 in the circumferentially arranged recess 306, thus preventing tilting of the sealing ring 108.

It is to be understood that the present invention is not limited to the embodiment described above and illustrated in the drawings; rather, the skilled person will recognize that many changes and modifications may be made within the scope of the appended claims. For example, two gas tight piston rings as depicted in FIG. 2 may be used, where the two gas tight piston rings are preferably arranged opposed to each other.

1. A butterfly valve disc arrangement comprising:
a valve disc arranged to be rotatably movable between an open position and a closed position of a valve body, the valve disc comprising a circumferentially arranged recess disposed about a periphery of the valve disc;
a sealing ring arranged in the circumferentially arranged recess of the valve disc and configured to provide a radial seal against an inner surface of the valve body when the valve disc is arranged in the closed position; and
a resilient member arranged between a first surface of the circumferentially arranged recess and a first surface of the sealing ring for providing a seal between a second surface of the sealing ring and a second surface of the circumferentially arranged recess, wherein the sealing ring comprises an axially extending protruding portion at a radially lower portion of the sealing ring, the protruding portion extending from the first surface, in a direction away from the first surface of the sealing ring, wherein an upper surface of the axially extending protruding portion of the sealing ring is arranged at a non-zero distance from a radially lower portion of the resilient member when the valve disc is arranged in the closed position.

2. The butterfly valve disc arrangement according to claim 1, wherein the resilient member is an axial spring.

3. The butterfly valve disc arrangement according to claim 1, wherein the resilient member is a continuous axial spring extending around the circumferential direction of the recess.

4. The butterfly valve disc arrangement according to claim 1, wherein the first and second surfaces of the sealing ring are axially opposed surfaces arranged on each side of the sealing ring.

5. The butterfly valve disc arrangement according to claim 1, wherein the sealing ring is a piston ring comprising a circumferentially extending protrusion at a first end portion of the piston ring and a groove portion at a second end portion of the piston ring, the circumferentially extending protrusion being arranged in the groove portion.

6. The butterfly valve disc arrangement according to claim 1, wherein the circumferentially arranged recess comprises a protruding portion extending in a direction towards the sealing ring.

7. A butterfly valve comprising a valve body and a butterfly valve disc arrangement, wherein the butterfly valve disc arrangement comprises:
a valve disc rotatably movable between an open position and a closed position of the valve body, the valve disc comprising a circumferentially arranged recess disposed about a periphery of the valve disc;
a sealing ring arranged in the circumferentially arranged recess of the valve disc and configured to provide a radial seal against an inner surface of the valve body when the valve disc is arranged in the closed position; and
a resilient member arranged between a first surface of the circumferentially arranged recess and a first surface of the sealing ring for providing a seal between a second surface of the sealing ring and a second surface of the circumferentially arranged recess, wherein the sealing ring comprises an axially extending protruding portion at a radially lower portion of the sealing ring, the protruding portion extending from the first surface, in a direction away from the first surface of the sealing ring, wherein an upper surface of the axially extending protruding portion of the sealing ring is arranged at a non-zero distance from a radially lower portion of the resilient member when the valve disc is arranged in the closed position.
